(19) United States
(12) Patent Application Publication
(10) Pub. No.: US 2026/0249797 A1
(43) Pub. Date: Aug. 27, 2026

(54) FRONT ENERGY ABSORBER FOR A VEHICLE

(71) Applicant: FCA US LLC, Auburn Hills, MI (US)

(72) Inventors: Girish Kumara Attinamane, Auburn Hills, MI (US); Charles R. Buttler, Auburn Hills, MI (US); Kalid S. Jaboo, Auburn Hills, MI (US)

(21) Appl. No.: 19/059,420

(22) Filed: Feb. 21, 2025

(51) Int. Cl. B60R 19/18; B60R 19/48; B60R 19/50

(52) U.S. Cl. CPC B60R 19/18; B60R 19/483; B60R 19/50; B60R 2019/186; B60R 2019/1886

(57) ABSTRACT

An energy absorbing structure for a vehicle includes a unitary structure having an upper portion sized to extend across the vehicle. The upper portion has a first stiffness. A lower portion is sized to extend across the vehicle. The lower portion has a second stiffness greater than the first stiffness.

### FIELD

The present disclosure relates to an energy absorbing structure for a front of a vehicle, and, more specifically, to an energy absorbing structure that also acts as supporting structure for various components.

### BACKGROUND

This section provides background information related to the present disclosure which is not necessarily prior art.

In vehicle design, a front fascia is the decorative portion outside the front area or bumper of the vehicle. The front fascia typically has an energy absorber used to absorb the energy in a crash. The front fascia and any energy absorber must accommodate headlamps and sensors. One challenge is that critical components need to be protected in their different positions for various heights during a crash event. That is, governmental bodies have energy absorption standards that must be met at different heights when an air suspension is at a raised, lowered and a nominal height. Preventing damage in different situations to the headlamps and sensors under certain conditions is desirable.

Design considerations may not always allow for the redesign of a front fascia because the desired look may be altered. However, common solutions such as foam may not be sufficient due to the close proximity of the front components.

It is very common for vehicles to have packaging issues. With the number of electronic devices included in the vehicles, packaging components in other places is often difficult. Some components such as headlamps, radars and other sensors are suitably positioned in the front fascia of the vehicle. Protecting these components while meeting impact requirement may be difficult.

### SUMMARY

This section provides a general summary of the disclosure and is not a comprehensive disclosure of its full scope or all of its features.

The present disclosure provides an energy disclosures for a front end a vehicle that accommodates designs with a small amount of clearance space and allows designs to meet modern government crash standards while providing protection to sensors and headlamps.

In one aspect of the disclosure, an energy absorbing structure for a vehicle includes a unitary structure having an upper portion sized to extend across the vehicle. The upper portion has a first stiffness. A lower portion is sized to extend across the vehicle. The lower portion has a second stiffness greater than the first stiffness.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of a front end of a vehicle having an energy absorber therein.

FIG. 1B is a perspective view of the fascia of the vehicle in a semi-transparent mode so the energy absorber there behind is illustrated.

FIG. 2 is a cross-sectional view of the front end of the vehicle having a fascia and an energy absorbing structure.

FIG. 3A is a perspective view of the energy absorber relative to the head lamps and a signature lamp.

FIG. 3B is a front view of the energy absorber of FIG. 3A.

FIG. 3C is a top view of the energy absorber of FIGS. 3A and 3B.

FIG. 3D is a side view of the energy absorber relative to the sensors.

FIG. 4A is a perspective view of the energy absorber.

FIG. 4B is a top view of the energy absorber.

FIG. 4C is a rear review of the energy absorber.

Corresponding reference numerals indicate corresponding parts throughout the several views of the drawings.

### DETAILED DESCRIPTION

Example embodiments will now be described more fully with reference to the accompanying drawings.

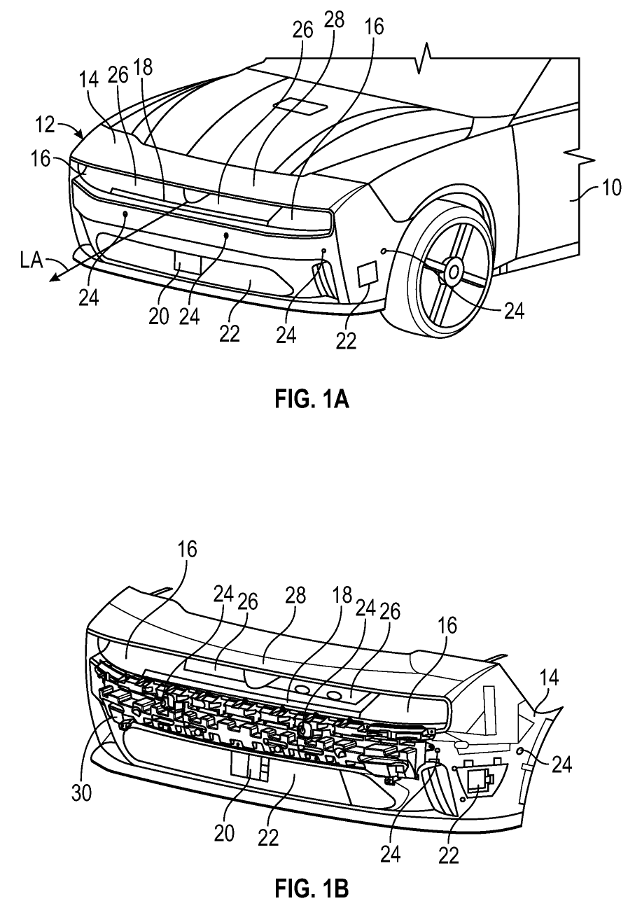

Referring now to FIGS. 1A and 1B, a vehicle 10 having a front end 12 is depicted relative to a longitudinal axis LA. While the present disclosure is specifically suited for a front end, the energy absorber may be used in a rear end of the vehicle 10. Examples of a type of vehicle 10 include, but are not limited to, internal combustion engine vehicles (ICE), battery electric vehicles (BEV), hybrid electric vehicle (HEV), plug-in hybrid electric vehicle (PHEV), range extending electric vehicles (REV) and fuel cell electric vehicles (FCEV).

In the depicted example, the vehicle 10 has a fascia 14 that is molded around and holds many of the components in the front of the vehicle. The fascia 14 may secure headlights 16, a signature lamp 18, a long range radar 20 and medium range radars 22, one of which is illustrated on one side of the fascia 14. Other components of the front end 12 of the vehicle may include active shutters and park assist sensors 24.

Various governmental bodies have requirements for absorbing energy during a crash event. As is best illustrated in FIG. 1B, an energy absorber 30 is provided behind the fascia 14. The energy absorber 30 allows various crash standards to be met such as the pendulum test and various other offset tests.

The fascia 14 may be stylized in different forms to include air intakes 26 and a front spoiler 28. In certain vehicles, the front intake 26 may be enclosed and for styling purposes only. The fascia 14 may be thin plastic or other composite material behind which the energy absorber 30 is positioned.

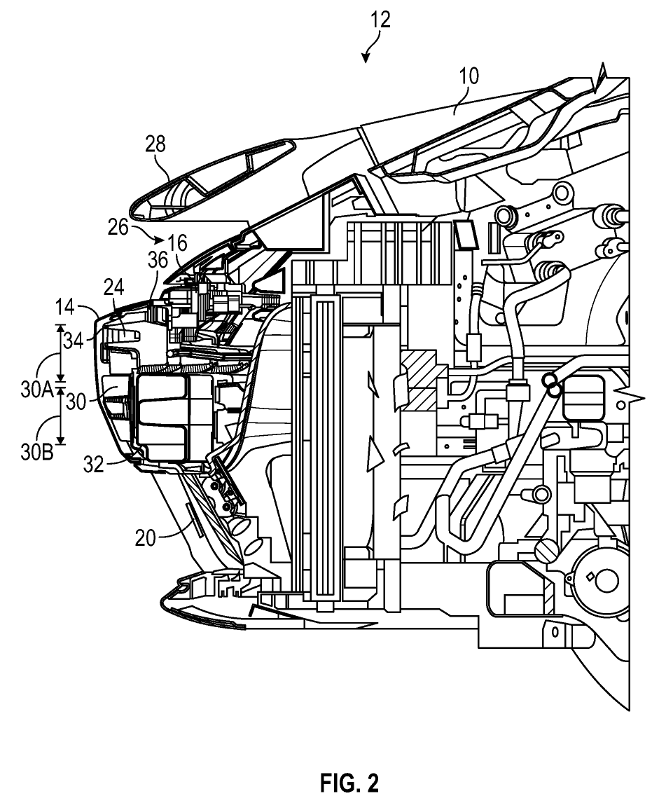

Referring now also to FIG. 2, a cross-sectional view of the front end 12 of the vehicle 10 is set forth. In this example, the energy absorber structure or energy absorber 30 is disposed in front of a bumper 32. As is best illustrated in FIG. 1B, the energy absorber 30 extends across the front of the vehicle and slightly wraps around to the side of the vehicle. The energy absorber 30 may have the sensor 24 mounted therein. That is, spaces or openings may be left in the energy absorber to allow parking sensors 24 to be positioned therein. In the present example, six sensor openings 34 may be provided to support six parking sensors 24.

The energy absorber 30 may be formed from various types of material including Xenoy. In the present example, the energy absorber 30 has an upper portion 30A and a lower portion 30B. The upper portion is sized to extend across the vehicle 10 and has a first stiffness. Because the upper portion 30A extends deeper longitudinally relative to the vehicle, the stiffness of the upper portion 30A may be reduced compared to that of a lower portion 30B. The upper portion 30A may have fasteners 36 that extend into the upper portion 30A. The upper portion 30A may also be referred to as a fascia mounting bracket since the fascia 14 is supported thereby.

The lower portion 30B has a higher stiffness than the upper portion 30A. The stiffness of the lower portion 30B may be controlled by the number of lobes and ribs as will be described in greater detail below. The lower portion 30B is directly longitudinally in front of the bumper 32 and, in this example, tapers inwardly at the bumper 32 as does the fascia 14. It is desirable to provide the energy absorber 30 configured in such a manner so as to minimize the damage to headlights 16, the parking sensors 24, the long range radar 20 and the medium range radar 22.

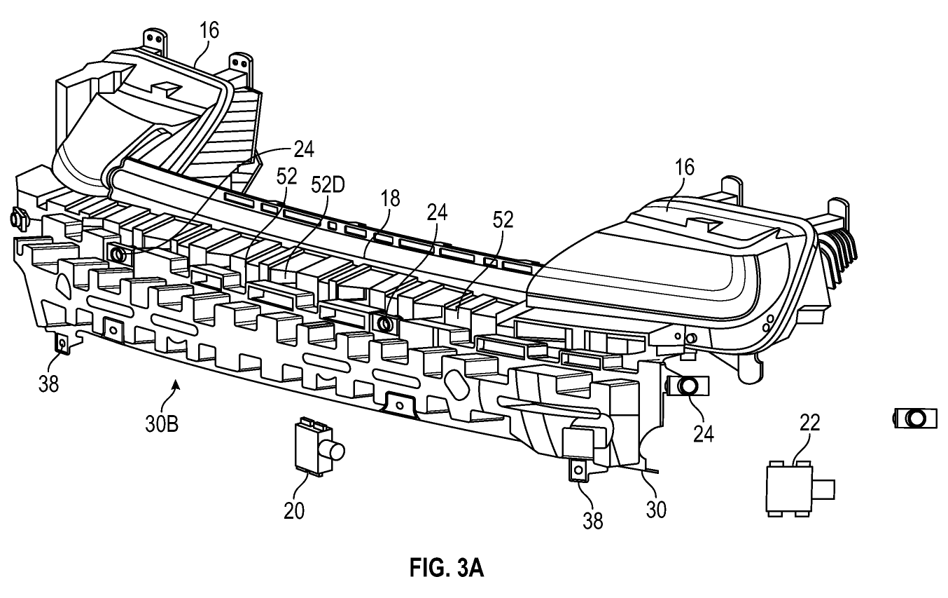

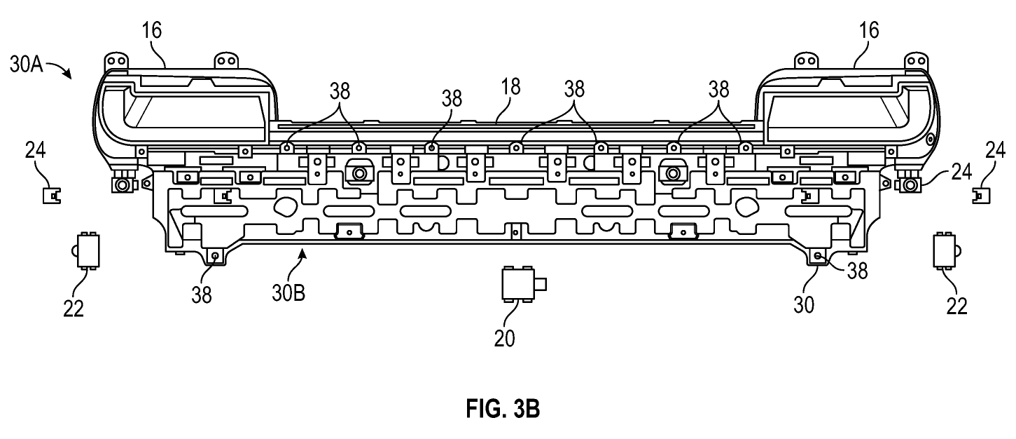

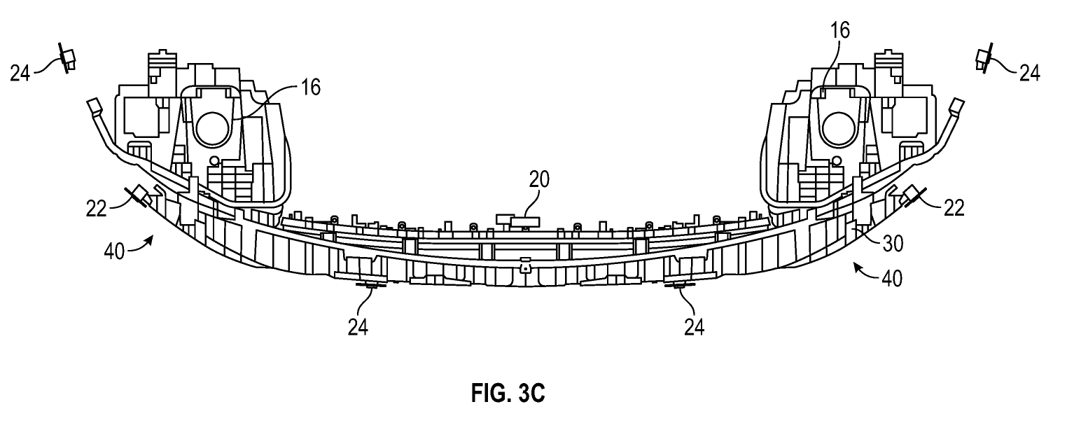

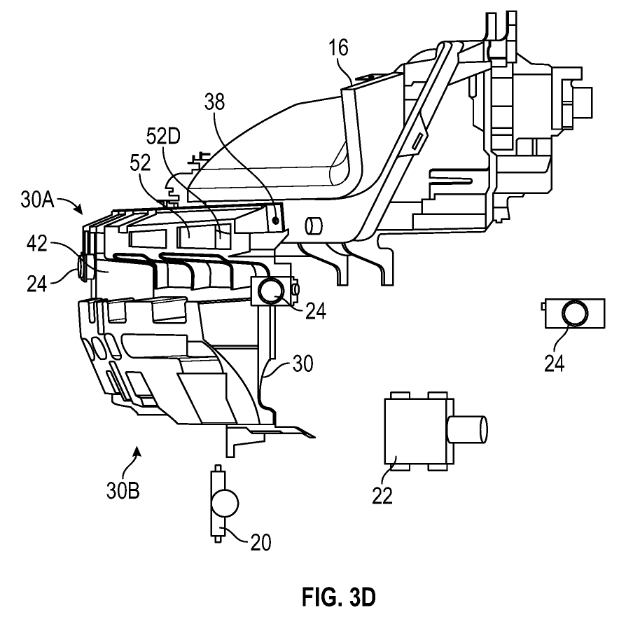

Referring now to FIGS. 3A-3D, the front fascia 14 illustrated above has been removed to reveal the headlights 16 and signature lamp 18 supported by the upper portion 30A.

A mounting opening 38 used for receiving fasteners may be positioned at various locations on the upper portion 30A and the lower portion 30B for securing the fascia and/or other components such as the headlights 16 and the signature lamp 18 to the energy absorber.

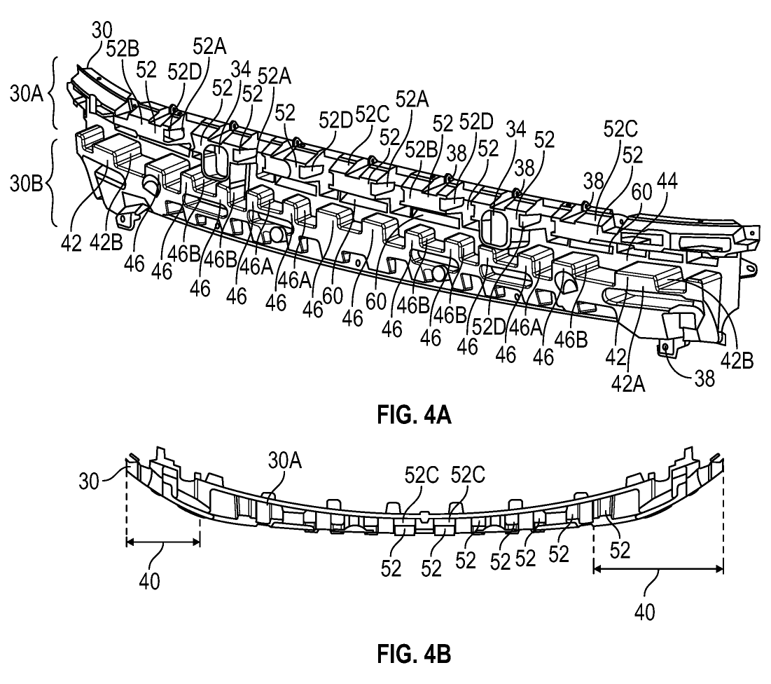

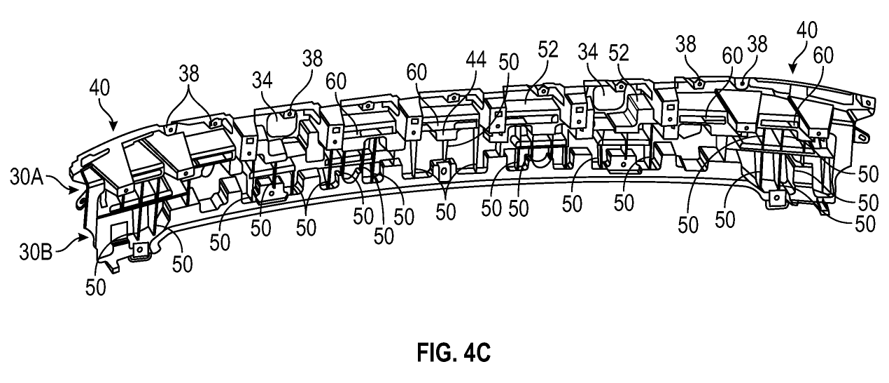

Referring now also to FIGS. 4A-4C, the front, top and rear views of the energy absorber 30 are illustrated. As is best illustrated in FIG. 4B, curved portions 40 are used near the corners of the vehicle. The curved portions 40 have lobes 42 that are formed below the headlights16 to reduce the amount of damage during an impact to the headlights 16. The lobes 42 are generally rectangular in shape and extend outward or forward longitudinally from a base 44. Other lobes 46 are positioned across the width of the energy absorber 30 to allow the energy to be absorbed within the vehicle. The size of the lobes 42, 46 may be determined experimentally by computer engineering based on various materials, conditions, weights and components within the vehicle. In general, the lobes 42, 46 are rectangular and have front surfaces 42A, 46A. As is best illustrated in FIG. 4C, the lobes 42, 46 may have ribs 50 that are integrally molded therein. The ribs 50 extend vertically and change the stiffness of the lobes. The number of ribs 50 within the rear portions of the lobes may change depending on the desired crash characteristics. In general, the ribs 50 increase the stiffness of the lower portion 30B. Each of the lobes also has longitudinally extending walls 42B, 46B. The walls 46B extend longitudinally to form the generally rectangular shaped lobes 42, 46.

The upper portion 30A of the energy absorber 30 also includes lobes 52. Lobes 52 extend generally longitudinally relative to the vehicle. The lobes 52 have longitudinally extending sidewalls 52A. In this example, the lobes 52 have the sidewalls 52A that are coupled to a front wall 52B. That is, the front wall 52B extends between sidewalls 52A to form the lobe 52. Upper and lower walls 52C are used to form the entire lobe. That is, the lobe is formed by upper walls 52C, sidewalls 52A and the front wall 52B.

Some of the lobes 52 may have a sensor openings therein for receiving parking sensors 24. The sensor

As mentioned above, the upper portion 30A preferably has a reduced stiffness from that of the lower portion 30B. In this example, pockets 52D are provided by forming openings through the sidewalls 52A. The pockets 52D may also be partially formed by openings in the front wall 52B. The size of the pockets 52D may vary depending upon the amount of stiffness desired in the upper portion 30A. Two of the front lobes 52 have openings 34 for receiving the park assist sensors.

Openings 60 may be spaced across the energy absorber 30 beneath the lobes 52 to delineate the upper portion 30A and the lower portion 30B. That is, the openings may be in the upper portion 30A just above the lower portion 30B.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An energy absorbing structure for a vehicle comprising:
a unitary structure comprising;
an upper portion sized to extend across the vehicle, the upper portion comprising a first stiffness; and
a lower portion sized to extending across the vehicle, the lower portion comprising a second stiffness greater than the first stiffness.

2. The energy absorbing structure of claim 1 wherein the unitary structure has mounting openings.

3. The energy absorbing structure of claim 2 wherein the mounting openings are configured to mount the unitary structure to the vehicle.

4. The energy absorbing structure of claim 1 wherein the upper portion forms a fascia mounting bracket.

5. The energy absorbing structure of claim 1 wherein the upper portion comprises a first plurality of lobes extending forward relative to the vehicle.

6. The energy absorbing structure of claim 5 wherein the first plurality of lobes comprises a plurality of pockets to reduce stiffness in the upper portion.

7. The energy absorbing structure of claim 5 wherein each lobe of the first plurality of lobes comprises a first pocket and a second pocket.

8. The energy absorbing structure of claim 5 wherein each lobe of the first plurality of lobes comprises a front wall, a first sidewall and a second sidewall.

9. The energy absorbing structure of claim 8 wherein a first lobe of the first plurality of lobes comprises a first pocket.

10. The energy absorbing structure of claim 9 wherein the first pocket comprises an opening in the first sidewall.

11. The energy absorbing structure of claim 9 wherein the first pocket comprises an opening in the first sidewall and the front wall.

12. The energy absorbing structure of claim 9 wherein the first lobe comprises a sensor opening in the front wall.

13. The energy absorbing structure of claim 5 wherein the lower portion comprises a second plurality of lobes extending longitudinally.

14. The energy absorbing structure of claim 13 wherein the second plurality of lobes comprise ribs disposed therein.

15. The energy absorbing structure of claim 14 wherein the ribs extend vertically.

16. A vehicle comprising:
the energy absorbing structure of claim 1; and
a bumper;
wherein the lower portion is disposed in front of the bumper.

17. The vehicle of claim 16 further comprising a fascia that is tapered inwardly adjacent to the bumper.

18. The vehicle of claim 17 wherein the upper portion forms a fascia mounting bracket for securing the fascia thereto.

19. The vehicle of claim 17 wherein the fascia comprises a long range radar mounted thereto below the lower portion.

20. The vehicle of claim 16 further comprising a first headlight and a second headlight, wherein the lower portion comprises a first lobe disposed below the first headlight and a second lobe disposed below the second headlight.
